(19) United States
(12) Patent Application Publication
(10) Pub. No.: US 2024/0407027 A1
(43) Pub. Date: Dec. 5, 2024

(54) FIRST NODE AND METHODS PERFORMED THEREBY FOR HANDLING AGGREGATION OF MESSAGES

(71) Applicant: Telefonaktiebolaget LM Ericsson (publ), Stockholm (SE)

(72) Inventors: Konstantinos VANDIKAS, Solna (SE); Wenfeng HU, Täby (SE); Martin ISAKSSON, Stockholm (SE); Adriano MENDO MATEO, Málaga (ES); Erik SANDERS, Vallentuna (SE)

(73) Assignee: Telefonaktiebolaget LM Ericsson (publ), Stockholm (SE)

(21) Appl. No.: 18/698,359

(22) PCT Filed: Feb. 21, 2022
(86) PCT No.: PCT/EP2022/054192

§ 371 Date: Apr. 4, 2024

(30) Foreign Application Priority Data
Nov. 8, 2021 (GR) 20210100775

(51) Int. Cl. H04W 76/15; H04W 24/04; H04W 24/08; H04W 84/18

(52) U.S. Cl. CPC H04W 76/15; H04W 24/04; H04W 24/08; H04W 84/18

(57) ABSTRACT

A method performed by a first node for handling aggregation of messages is disclosed. The first node determines out of a plurality of nodes, which nodes are to be paired as a pair of nodes. The pairing is to pass messages to another node for aggregation of information comprised in the messages. The information is to be masked by respective masks of opposite signs. The respective masks are to prevent the another node from accessing the information while enabling their aggregation. The determining is based on a respective measure of reliability of communications of a second node and a third node in the pair of nodes being similar, according to a criterion. The first node initiates an aggregation of the messages passed from the determined pair of nodes to the another node.

### TECHNICAL FIELD

The present disclosure relates generally to a first node and methods performed thereby for handling aggregation of messages. The present disclosure further relates generally to computer programs and computer-readable storage mediums, having stored thereon the computer programs to carry out these methods.

### BACKGROUND

Computer systems in a communications network may comprise one or more network nodes. A node may comprise one or more processors which, together with computer program code may perform different functions and actions, a memory, a receiving port and a sending port. A node may be, for example, a server, a computer managing a cell, a core network node, etc. Nodes may perform their functions entirely on the cloud.

The communications network may cover a geographical area which may be divided into cell areas, each cell area being served by another type of node, a network node in the Radio Access Network (RAN), radio network node or Transmission Point (TP), for example, an access node such as a Base Station (BS), e.g. a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood as a node providing radio coverage to a geographical area, under management of a base station. One base station, situated on the base station site, may serve one or several cells. Further, each base station may support one or several communication technologies. The telecommunications network may also be a non-cellular system, comprising network nodes which may serve receiving nodes, such as user equipment's, with serving beams.

A Third Generation Partnership Project (3GPP) system comprising a Fifth Generation (5G) RAN, a 5G Core Network and a User Equipment (UE) may be referred to as a 5G system.

The nodes comprised in a communications network may have relations among them, and send, or pass, information to one another, based on whether a relation may exist between them or not. An example of relations may be Automatic Network Relations (ANR), which may be understood to mean that a UE e.g., connected to Cell A, may receive Cell B with RSRP>t→. This may be understood to mean that Cell A relates to Cell B. Another type of relations may be understood to be the existence of an Xn interface between Cell A and Cell B which may be understood to mean that the cells may be physically connected with a link. In addition, there may be microwave links between different cells. The fact that nodes comprised in a communications network may have relations among them may results in that the different nodes and their interrelationships in a communications network may be represented as a graph, where a vertex may be understood to be a node, and a relationship between two vertices may be understood to be an edge. This in turn may be understood to mean that the different nodes and their interrelationships in a communications network may be used as input to a Graph Neural Network (GNN), which may then produce a representation of them in latent space. Such a representation may be used as input to a regular neural network, thus enabling the neural network to learn from non-tabular data such as graphs. Graph Neural Networks (GNNs) may be understood as a type of machine learning method that may be designed to analyze data described by graphs. GNNs may be used to make predictions based on the data described by the graphs.

Cells may be understood to typically collect UE related information, which may be personal and sensitive and may be required to not be exposed. Furthermore, information collected in cells, for example, related to deployment or parameters, may also be sensitive from a perspective of an operator of the communications network. Even though the communication of such information may be performed over encrypted networks, if exchanged without using a privacy aware mechanism, trusted processes that may be running in a cell may accidentally or intentionally access this information and, as such, observe, and perhaps expose, private or sensitive information.

An important example case may be when dealing with cells from multiple operators such as in the context of roaming. Roaming agreements between operators may be understood to mean that cell relations may exist between cells that may belong to different operators. If such nodes are used in this context, one operator may have the potential of deriving utilization and other sensitive information of the cells that may handover traffic to their cells, thereby breaching its privacy.

Within the context of GNNs, nodes, which may correspond to the vertices in a graph, may exchange information, as messages, in a process referred to as message passing. Message passing, also known as node-based message passing, may be understood to be one of the most popular techniques used in GNNs because of how simple it may be to implement and because its computational cost, that is, memory and processing, may be understood to be linear to the number of nodes.

Message-passing may be understood to refer to a process whereby nodes basically spread node features to neighboring nodes using trainable weights and aggregation functions, either with respect to the distance between nodes, e.g., number of hops, or the connected node/edge features. The process may be described using a sequence diagram such as that depicted in FIG. 1. Message passing may be performed with or without secure aggregation, meaning, preserving the privacy of the message payload, or without. FIG. 1 is a schematic diagram depicting an example of message passing without secure aggregation. In FIG. 1, node 1, node 2 and the reference node may be seen as three different nodes or cells in a communications network. The relationship between these nodes/cells may be extracted by a Network Relations Table (NRT) which may be maintained, among others, by an Automatic Neighbour Relation (ANR) feature which may be available in 3GPP networks. A radio network node may maintain an NRT for each cell. Each entry in the NRT may contain information the radio network node may need to know about a neighbor, such as its identity, whether or not it may be used for handover procedures, etc., In step 1 of FIG. 1, node1 uses a feed forward neural network to produce an embedding of its own features and its neighboring node features, e.g., energyConsumption, such as pmConsumedEnergy, and/or Radio Resource Control RRC connections, such as rrcConnEstab. In step 2, Node 2 does the same using another feed forward network that has the same or compatible architecture to the one used by node 1. Compatible here may be understood to mean that the output of each model may be the same. Still the input and the number and/or shape of hidden layers may vary. In step 3, the reference node aggregates these messages by creating the sum, which yields a new vector named H. This vector has been produced by combining the features of node 1 and node 2, and as such, may capture information from both. This would have been otherwise impossible to capture since these features would need to be copied and then represented in a tabular form. In that case, it may be needed to copy in every node all the features from all the nodes belonging to the N-hop neighbors, which is quite inefficient. To represent features in a tabular form is problematic when representing relationships, as it may yield very sparse matrices. This may be understood to be undesirable as a lot of space may be consumed to store a matrix that may have very little information. Furthermore, it may be necessary to process a very large matrix, where there may be little valuable information, as most parts of it may be empty. In addition, copying such information may be impossible if there is not enough bandwidth in the network, or due to privacy related regulations.

The main limitation that may be identified in this approach is that a malicious or honest-but-curious version of the reference node may potentially reconstruct data samples used in training that node 1 or node 2 used to produce its embeddings, which may be problematic privacy-wise.

One way to solve this problem may be to make use of techniques from secure multi party computation, such as secure aggregation, as described in K. Bonawitz et.al Practical Secure Aggregation for Privacy-Preserving Machine Learning, which may allow negotiating shared secrets between pairs of nodes that may be participating in this exchange. These shared secrets may be generated between pairs of nodes. The shared secrets may be used to generate masks that may be known by the pairs of nodes, and not by the reference node which may be tasked with performing the sum of the embeddings. The process is illustrated in FIG. 2. FIG. 2 is a schematic diagram depicting an example of message passing with secure aggregation. For simplicity, the exchange of cryptographic keys, and the generation of secret masks between the nodes is omitted from FIG. 2, since the aim of FIG. 2 may be understood to be to show the basic function of secure aggregation. The basic function of secure aggregation may be understood to be that of producing random masks negotiated between a pair of nodes, herein node1 and node2, and thereafter, have these masks cancelled out while being used to produce the sum, or the average, of the embeddings. In this example, there is a pair of two nodes, node 1 and node 2. In step 1, node 1 generates a random mask, which is acknowledged by node 2 in step 2. In step 3, node1 uses a feed forward neural network to produce an embedding of its own features and its neighboring node features, and adds the random mask. In step 4, Node 2 does the same using another feed forward network that has the same or compatible architecture to the one used by node 1, and subtracts the random mask. In step 5, the reference node aggregates these messages by creating the sum, which yields a new vector named H. The random masks have cancelled themselves out by their addition. This vector has been produced by combining the features of node 1 and node 2, and as such, may capture information from both. The secure aggregation procedure illustrated in FIG. 2 may therefore be used to aggregate information from different nodes in a communications network, while preserving the privacy of the aggregated payloads.

FIG. 3 illustrates a setup, wherein multiple nodes are available to form pairs in a general case for secure aggregation. Every node is schematically represented as a circle. All the nodes which may be available to establish pairs among them may be considered to form a list. In this list is a potential candidate and it may either be a cell or a node in a telecommunications network. Out of the 8 nodes that are visualized in this example, on the top row of FIG. 3, it may be possible to generate 28 different pairs, that is, 8 choose 2. A family may be understood to be a set of different pairs in which all the elements may be involved in a pair. Combining these pairs into families, each containing 4 pairs may be understood to result in 7 different families to choose from. Two examples out of these seven possible families to choose from are depicted in the second and third row from the top, as Family 1 and Family 2, respectively. Every number inside the circles on the depicted families indicates the node number, and in parenthesis, the sign of the random mask. The horizontal lines between the nodes in FIG. 3 indicate the formed pairs.

FIG. 4 is a schematic diagram illustrating cancellation of masks, as described in http://kth.diva-portal.org/smash/get/diva2:1591638/FULLTEXT01.pdf. The rectangles stacked on the far left side of the Figure represent, each of the 8 selected nodes, wherein NF denotes Network Function. The row to the right of each of the depicted rectangles represents the aggregation of the messages of the nodes. Each aggregation is represented as two halves, wherein each is filled with the pattern of the node the message of which is being aggregated in the pair. The origin of the messages is further represented by the numbers in parenthesis to the right of each “m”, which denotes mask. Each of the 8 selected nodes add masks for every other selected node, as indicated by the minus and plus signs to the left of every two halves. The cancellation of masks is indicated by the curved arrows. Each mask above the diagonal is cancelled out by a mask below the diagonal. The cancellations of masks do not affect the sum. For every row, ω* denotes the weights of the neural network.

The application of secure aggregation may be understood to require identifying pairs of nodes, or cells or subgraphs, which may then be used to generate random masks. Pairs may be formed to hide information whenever it may be desired to create the sum of hidden information, using a random mask, which may provide privacy. Even though this may be a seemingly simple process it may become very challenging and result in erroneous aggregation and/or loss of information.

### SUMMARY

As part of the development of embodiments herein, one or more challenges with the existing technology with regards to roaming in a communication network will first be identified and discussed.

The nodes that may be chosen from to form pairs in a communications network in order to aggregate information may be anywhere geographically, and they may or may not be able to talk to each other directly due to lack of proximity, absence of wired connection or due to interference when short range communication techniques may be used.

Identifying pairs of nodes, or cells or subgraphs, which may then be used to generate random masks may become very challenging when it may be necessary to choose between multiple nodes that may or may not be available all the time. This may be understood to be because once chosen, the pairs may not be separated since one node may be understood to have to provide the + (plus) side of the aggregation, and the other the − (minus). If there is a failure and one of the nodes in the pair cannot provide its part, both may need to be excluded. Otherwise, part of the input will not be cancelled out, and the aggregation will be erroneous. If they are cancelled out, for example, in a case where a reliable node may be paired with an unreliable node, then there will be loss of information.

In view of the foregoing, it is an object of embodiments herein to improve the handling aggregation of messages. It is a particular object of embodiments herein to improve the handling of aggregation of messages in a communications system. According to embodiments herein, the choice of pairs may take into consideration how reliable each pair is.

According to a first aspect of embodiments herein, the object is achieved by a method, performed by a first node. The method may be understood to be for handling aggregation of messages. The first node operates in a communications system comprising a plurality of nodes.

The first node determines, out of the plurality of nodes, which nodes are to be paired as a pair of nodes. The pair of nodes is to pass messages to another node for aggregation of information comprised in the messages. The information is to be masked by respective masks of opposite signs. The masks are to be assigned to the nodes comprised in the pair nodes. The respective masks are to prevent the another node from accessing the information respectively comprised in the respective messages passed from the pair of nodes while enabling their aggregation. The determining is based on a respective measure of reliability of communications of a second node and a third node comprised in the pair of nodes being similar according to a criterion. The first node is also configured to initiate an aggregation of the messages passed from the determined pair of nodes to the another node. The another node is a fourth node.

According to a second aspect of embodiments herein, the object is achieved by the first node. The first node may be considered to be for handling aggregation of messages. The first node is further configured to operate in the communications system configured to comprise the plurality of nodes. The first node is further configured to determine, out of the plurality of nodes, which nodes are to be paired as a pair of nodes. The pair of nodes is configured to pass messages to the another node for aggregation of information configured to be comprised in the messages. The information is configured to be masked by the respective masks of opposite signs configured to be assigned to the nodes comprised in the pair nodes. The respective masks are configured to prevent the another node from accessing the information configured to be respectively comprised in the respective messages configured to be passed from the pair of nodes while enabling their aggregation. The determining is configured to be based on the respective measure of reliability of communications of the second node and the third node configured to be comprised in the pair of nodes being configured to be similar according to the criterion. The first node is further configured to initiate the aggregation of the messages configured to be passed from the pair of nodes configured to be determined, to the another node. The another node is configured to be the fourth node.

According to a third aspect of embodiments herein, the object is achieved by a computer program, comprising instructions which, when executed on at least one processor, cause the at least one processor to carry out the method performed by the first node.

According to a fourth aspect of embodiments herein, the object is achieved by a computer-readable storage medium, having stored thereon the computer program, comprising instructions which, when executed on at least one processor, cause the at least one processor to carry out the method performed by the first node.

By, determining which nodes are to be paired as a pair of nodes based on the respective measure of reliability of communications of the second node and the third node being similar, the first node may enable to only build reliable pairs. This may be understood to reduce the likelihood that one member of the pair to become a drop-out, thus resulting in loss of information from both participants. In other words, the first node may be understood to prevent the physical loss of information comprised in the messages, while ensuring that privacy of the information comprised in the messages is preserved when aggregating the messages. Hence, the first node may enable a more robust handling of the data, since more data may be gathered and ultimately used for its analysis. This may in turn enable a more accurate analysis of the information. Since the information may, e.g., relate to an internal status of the communications system, this may in turn enable an improved maintenance of the operation of the communications system.

As a further advantage, the first node may enable that an operator of the communications system may run untrusted processes per node, since such processes may now be incapable of reading raw information from neighbouring nodes, thus preventing that sensitive information may be observed, and potentially exposed.

By initiating the aggregation of the messages passed from the determined pair of nodes to the another node, the first node may attempt to reduce the likelihood that information from both participants may be lost as a result of one of the members of the pair of nodes dropping out. As a further advantage, the first node may similarly enable that an operator of the communications system may run untrusted processes per node, since such processes may now be incapable of reading raw information from neighbouring nodes, thus preventing that sensitive information may be observed, and potentially exposed.

### BRIEF DESCRIPTION OF THE DRAWINGS

Examples of embodiments herein are described in more detail with reference to the accompanying drawings, and according to the following description.

FIG. 1 is a schematic diagram illustrating an example of message passing without secure aggregation, according to existing methods.

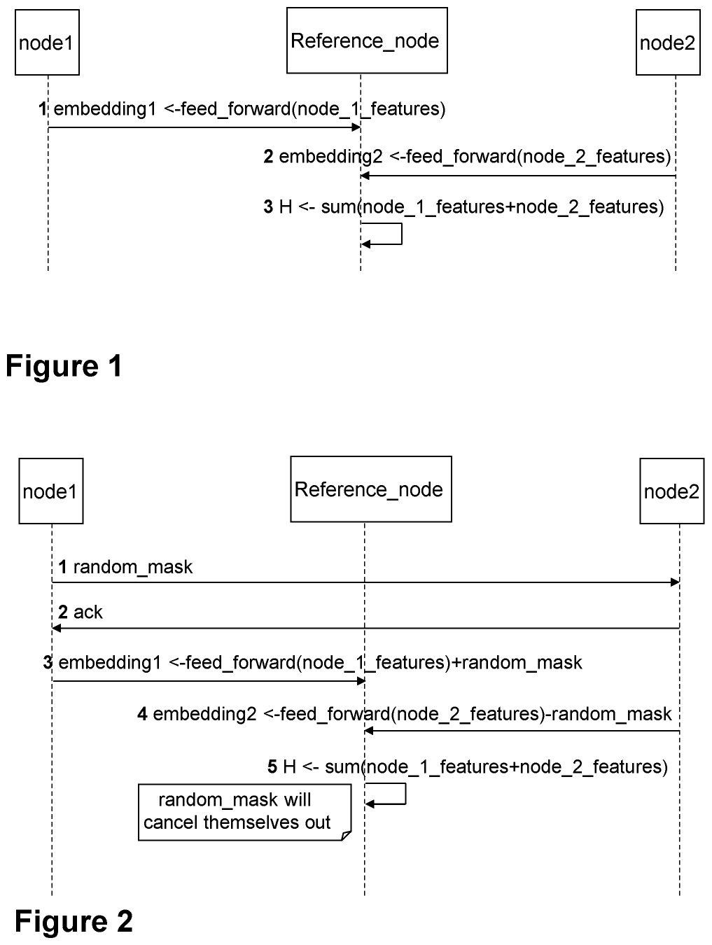

FIG. 2 is a schematic diagram illustrating an example of message passing with secure aggregation, according to existing methods.

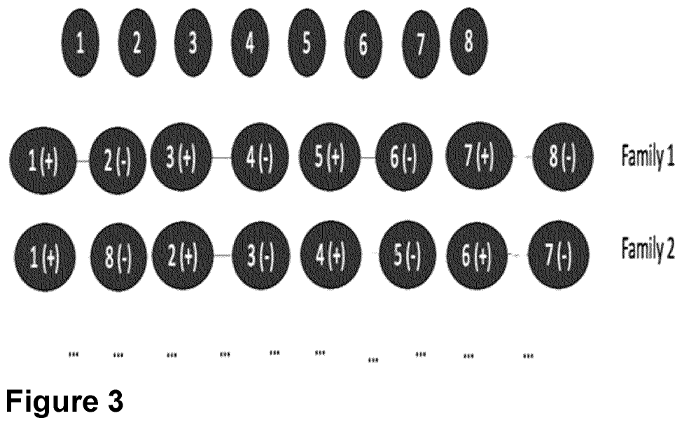

FIG. 3 is a schematic diagram illustrating an example of a general case for secure aggregation, according to existing methods.

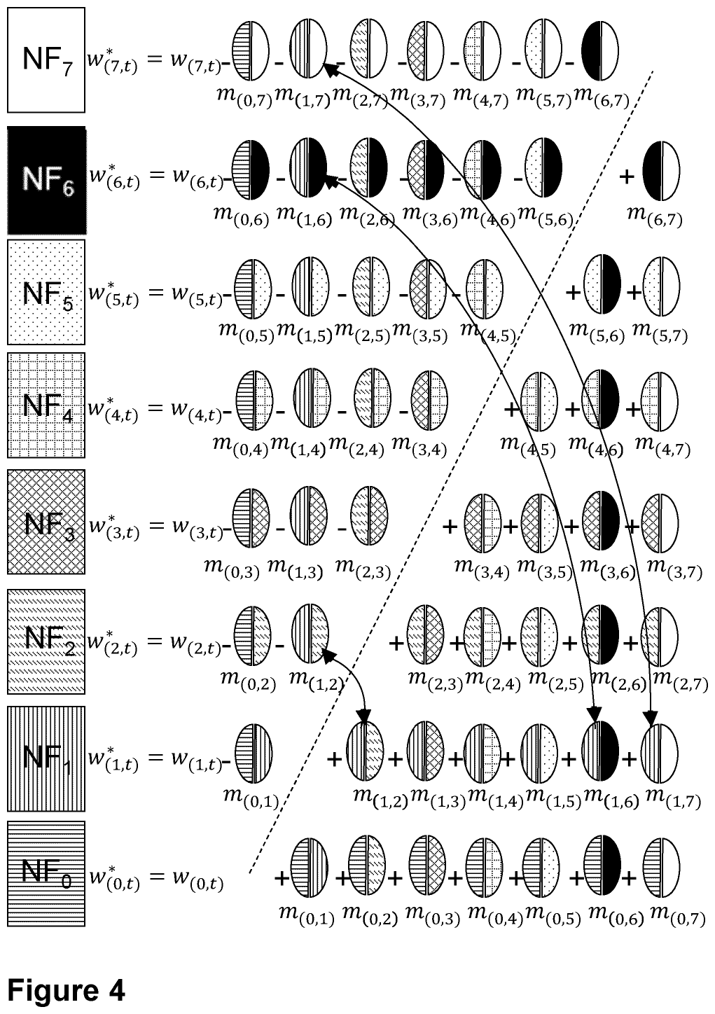

FIG. 4 is a schematic diagram illustrating an example of a general case for secure aggregation, according to existing methods.

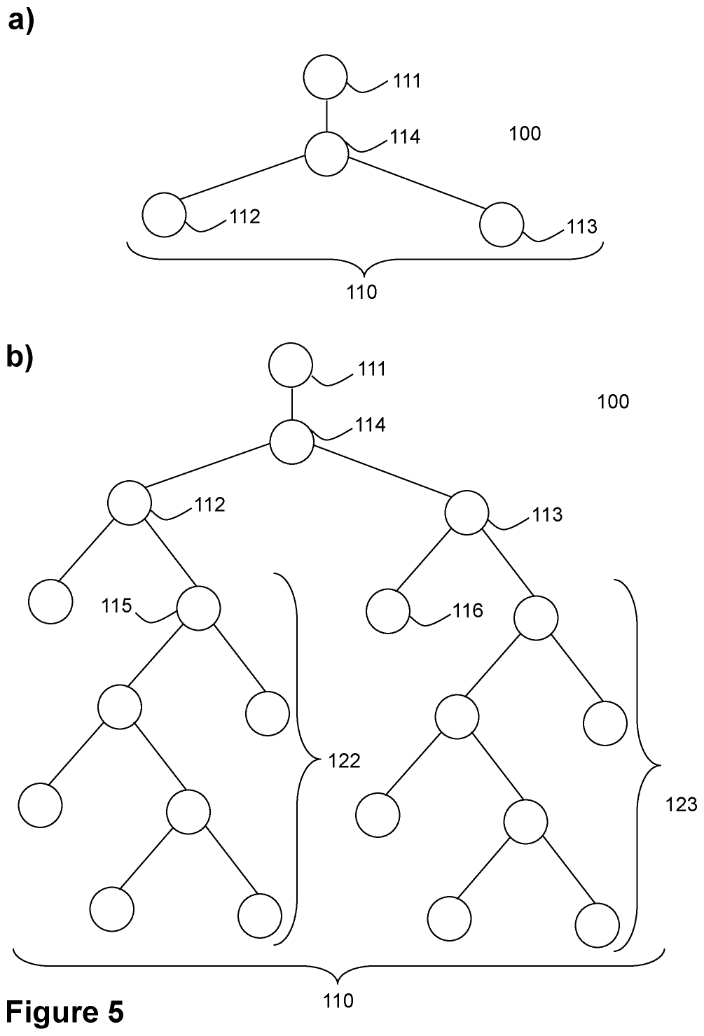

FIG. 5 is a schematic diagram illustrating a communications system, according to embodiments herein.

FIG. 6 depicts a flowchart of a method in a first node, according to embodiments herein.

FIG. 7 is a signalling diagram illustrating a non-limiting example of methods in a communications system, according to embodiments herein.

FIG. 8 is a signalling diagram illustrating another non-limiting example of methods in a communications system, according to embodiments herein.

FIG. 9 is a schematic block diagram illustrating two non-limiting examples, a) and b), of a first node, according to embodiments herein.

### DETAILED DESCRIPTION

Certain aspects of the present disclosure and their embodiments may provide solutions to the challenges discussed in the Summary section or other challenges. There are, proposed herein, various embodiments which address one or more of the issues disclosed herein.

As a brief overview, embodiments herein may be understood to relate to secure aggregation for message passing among nodes of a communication system, e.g., in a RAN, a core network (CN), an IoT network, a cloud network, etc.

As a general overview, embodiments herein may be understood to relate to a computer-implemented method for constructing pairs of nodes, e.g., cells, efficiently. This may be implemented, for example, by taking into consideration the information available in a Network Relations Table (NRT table). Since each node, e.g., cell, may be understood to have information about its neighboring nodes, this information may be used in embodiments herein to setup masks between the nodes that may be able to communicate reliably. That is, for example, masks are setup between nodes that may have sufficient resources to communicate, lack of interference, etc. In addition, this may be understood to improve the performance of the process since embodiments herein do not involve scanning arbitrarily for pairs, but instead rely on the locality of reference of each cell. The locality of reference of each cell may be understood as, for example the physical distance between the cells.

Since the NRT table may be understood to be designed to be automatically updated when new cells may be discovered by the UEs, the corresponding NRT entries may also be updated and, as such, the system may be understood to learn to communicate with new nodes and/or cells.

Embodiments herein may be understood to not be limited to sharing embeddings between neighboring cells. Embedding may be understood as an output of a feed forward neural network, one of the steps in the GNN building process. Embodiments herein may be used for sharing raw data, that is, raw counters, which may then become input to an aggregation function or another function which may itself be based on aggregation, such as averaging, without exposing their actual value. A counter may be understood as a performance measurement. Typically, a cell may generate many counters, which may measure many aspects of the cell performance: traffic, throughput, calls, etc.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

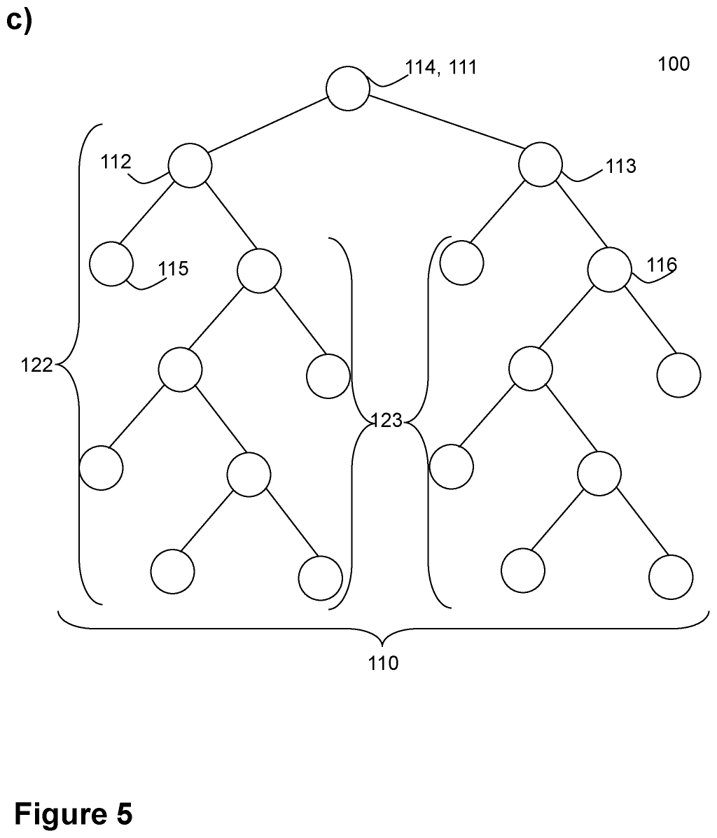

FIG. 5 depicts three non-limiting examples, in panel a), panel b) and panel c), respectively, of a communications system 100, in which embodiments herein may be implemented. The communications system 100 may be sometimes also referred to as a radio system, network or wireless communications system. The communications system 100 may be a cellular radio system or cellular network, for example, a network such as 5G system, or Next Generation network, or a newer system supporting similar functionality. In some examples, the communications system may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), UTRA TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of RATs such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as 6LowPAN, Bluetooth, or any cellular network or system.

The communications system 100 may comprise a plurality of nodes 110, whereof a first node 111, a second node 112, a third node 113 and a fourth node 114 are depicted in all three panels of FIG. 5. In some embodiments, such as that depicted in the non-limiting examples of panel b) and panel c) in FIG. 5, the communications system 100 may comprise a fifth node 115. In particular embodiments, such as that depicted in the non-limiting example of panel c) in FIG. 5, the communications system 100 may comprise a sixth node 116. The communications system 100 may be understood to comprise, as for example depicted in panel b) and panel c) of FIG. 5, one or more additional nodes. Each node is represented with a circle in FIG. 5.

Any of the first node 111, the second node 112, the third node 113, the fourth node 114, the fifth node 115, the sixth node 116 and any of the other nodes comprised in the plurality of nodes 110 operate in the communications system 100. Any of the first node 111, the second node 112, the third node 113, the fourth node 114, the fifth node 115, the sixth node 116 and any of the other nodes comprised in the plurality of nodes 110 may be understood, respectively, as a first computer system, a second computer system, a third computer system, a fourth computer system, a fifth computer system, a sixth computer system and another computer system. In some examples, any of the first node 111, the second node 112, the third node 113, the fourth node 114, the fifth node 115, the sixth node 116 and any of the other nodes comprised in the plurality of nodes 110 may be implemented as a standalone server in e.g., a host computer in the cloud. Any of the first node 111, the second node 112, the third node 113, the fourth node 114, the fifth node 115, the sixth node 116 and any of the other nodes comprised in the plurality of nodes 110 may in some examples be a distributed node or distributed server, with some of their respective functions being implemented locally, e.g., by a client manager, and some of its functions implemented in the cloud, by e.g., a server manager. Yet in other examples, any of the first node 111, the second node 112, the third node 113, the fourth node 114, the fifth node 115, the sixth node 116 and any of the other nodes comprised in the plurality of nodes 110 may also be implemented as processing resources in a server farm.

Any of the first node 111, the second node 112, the third node 113, the fourth node 114, the fifth node 115, the sixth node 116 and any of the other nodes comprised in the plurality of nodes 110 may be co-located, or be the same node. In typical examples, however, any of the first node 111, the second node 112, the third node 113, the fourth node 114, the fifth node 115, the sixth node 116 and any of the other nodes comprised in the plurality of nodes 110 may be different nodes. All the possible combinations are not depicted in FIG. 5 to simplify the Figure.

In other examples, of the first node 111, the second node 112, the third node 113, the fourth node 114, the fifth node 115, the sixth node 116 and any of the other nodes comprised in the plurality of nodes 110 may be comprised in the cloud. Any of the first node 111, the second node 112, the third node 113, the fourth node 114, the fifth node 115, the sixth node 116 and any of the other nodes comprised in the plurality of nodes 110 may be a core network node, of a core network.

In some non-limiting examples, the first node 111 may be an Operation and Maintenance (OAM) node node.

In some non-limiting examples, the fourth node 114 may be a packet gateway. The packet gateway may have multiple nodes, e.g., eNBs, physically connected to it. Any of the second node 112 and the third node 113 may communicate with the fourth node 114, where the fourth node 114 may process their input without knowing which nodes, e.g., eNBs, may be involved in that.

In some examples which are not depicted in FIG. 5, the communications system 100 may comprise one or more devices. Any of the wireless devices may be also known as e.g., a UE, mobile terminal, wireless terminal and/or mobile station, mobile telephone, cellular telephone, or laptop with wireless capability, or a Customer Premises Equipment (CPE), just to mention some further examples. Any of the wireless devices in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles, or any other radio network unit capable of communicating over a link in the communications system 100. Any of the wireless devices may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised within the communications system 100.

In some examples which are not depicted either in FIG. 5, the communications system 100 may comprise a plurality of radio network nodes. Any of the radio network nodes may typically be a base station or Transmission Point (TP), or any other network unit capable to serve a wireless device or a machine type node in the communications system 100. Any of the radio network nodes may be e.g., a 3G Node B (NB), a 4G eNB, a 5G gNB. The radio network node 140 may be e.g., a Wide Area Base Station, Medium Range Base Station, Local Area Base Station and Home Base Station, based on transmission power and thereby also coverage size. Any of the radio network nodes may be e.g., a gNB, a 4G eNB, or a 5G or alternative 5G radio access technology node, e.g., fixed or WiFi. Any of the radio network nodes may be a stationary relay node or a mobile relay node. Any of the radio network nodes may support one or several communication technologies, and its name may depend on the technology and terminology used. Any of the radio network nodes may be directly connected to one or more networks and/or one or more core networks.

Any of the radio network nodes may cover a geographical area which may be divided into cell areas, wherein each cell area may be served by a radio network node, although, one radio network node may serve one or several cells.

Any of the first node 111, the second node 112, the third node 113, the fourth node 114, the fifth node 115, the sixth node 116 and any of the other nodes comprised in the plurality of nodes 110 may communicate with each other over a respective link, e.g., a radio link or a wired link.

In general, the usage of “first”, “second”, “third”, “fourth”, “fifth” and/or “sixth”, herein may be understood to be an arbitrary way to denote different elements or entities, and may be understood to not confer a cumulative or chronological character to the nouns they modify.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

Although terminology from Long Term Evolution (LTE)/5G has been used in this disclosure to exemplify the embodiments herein, this should not be seen as limiting the scope of the embodiments herein to only the aforementioned system. Other wireless systems, support similar or equivalent functionality may also benefit from exploiting the ideas covered within this disclosure. In future radio access, e.g., in the sixth generation (6G), the terms used herein may need to be reinterpreted in view of possible terminology changes in future radio access technologies.

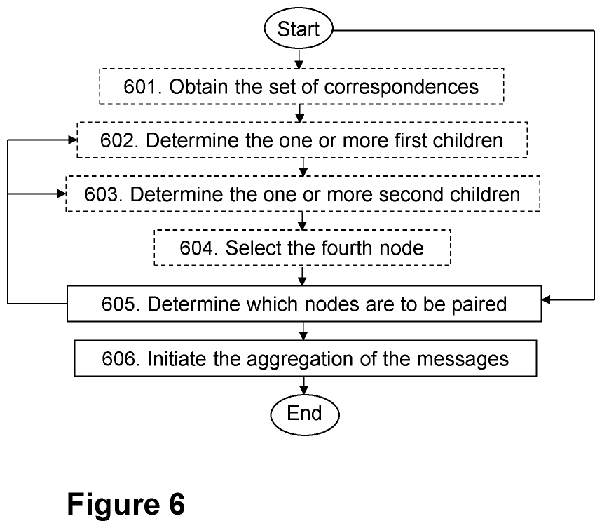

Embodiments of a method, performed by the first node 111, will now be described with reference to the flowchart depicted in FIG. 6. The method may be understood to be for handling aggregation of messages. The first node 111 operates in the communications system 100. The communications system 100 comprises a plurality of nodes 110.

Several embodiments are comprised herein. In some embodiments all the actions may be performed. In other embodiments, two or more actions may be performed. One or more embodiments may be combined, where applicable. All possible combinations are not described to simplify the description. It should be noted that the examples herein are not mutually exclusive. Components from one embodiment may be tacitly assumed to be present in another embodiment and it will be obvious to a person skilled in the art how those components may be used in the other exemplary embodiments. A non-limiting example of the method performed by the first node 111 is depicted in FIG. 6. In some examples, the Actions may be performed in a different order than that depicted in FIG. 6, as will be described below. For example, any of Action 603 and Action 604 may be performed, in some examples, after Action 605. In FIG. 6, actions which may be optional in some examples are depicted with dashed boxes.

### Action 601

In the course of operations of the communications network 100, any of the nodes in the plurality of nodes 110 may either receive or collect itself information comprising data which may, for example, indicate one or more features. That is, one or more aspects of a performance of the communications system 100 such as e.g., transmission rate in the node, which may be a certain cell. Such information may have to be sent to or towards a node which may itself have a capability to analyze the information, and, based on a result of such analysis, initiate taking an action enabling to address any potential performance issues that may be identified, or predicted, by the analysis performed. For example, the action may be an action relating to maintenance of the communications system 100. The analysis that may be performed may be, e.g., performed with machine learning methods. As a non-limiting example, the nodes in the plurality of nodes 110 may need to send the information in the case of a 5G network, to or towards an NWDAF node, and in the event the communications system 100 is a 4G network, to or towards an OAM node.

It may be understood that in some embodiments, each of the nodes in the plurality of nodes 110 may respectively comprise information on an individual node, or on a respective plurality of children nodes. That is, a “node” may correspond or map to a single node, or a node may correspond or map to a subgroup of nodes treated as a unity. Embodiments herein may be understood to operate on nodes/cells/subgraphs in the communications system 100, e.g., a telecommunication network, or in another graph as input. For simplicity, the term node is used herein to indicate any of these different options. Node herein may be used in the physical sense, while the term may maintain a functional parallel to is use in the mathematical definition of a graph. In other words, characteristics of GNN may be exploited in embodiments herein in the transfer and aggregation of information by the plurality of nodes 110 in the communications system 100.

The nodes in the plurality of nodes 110 may share the information respectively collected, and then aggregate it successively by pairs during its transfer towards the node that may compile the information for its eventual analysis. This transfer and aggregation of the information may be performed by the process of message passing described earlier. Particularly, in order to ensure that the information preserves its privacy, the message passing may be performed with secure aggregation. That is, pairs of nodes may be selected among the plurality of nodes 110, and then each of the nodes in the selected pair may mask the information by assigning respective masks of opposite signs to the nodes comprised in the pair nodes 112, 113. The respective masks may then prevent whichever node receives the information for aggregation may be able to access it, thereby preserving its privacy.

Embodiments herein may be understood to be drawn to determining which pairs of nodes in the plurality of nodes 110 may be most adequate to form pairs to aggregate their respective information efficiently. The first node 111 may be a node having the capability to determine pairs of nodes, as will be described later with Action 605.

In some embodiments, the determination of the pairs of nodes, which will be described later, may be implemented, instead of by scanning the plurality of nodes 110 arbitrarily for pairs, by instead taking into consideration how reliable they may be, communication wise. One of the aspects that may contribute to the reliability of the communication may be by relying on the locality of reference of each node. The goal of embodiments herein may be understood to be to ultimately take into account whether or not nodes to be paired may be able to communicate reliably. That is, for example, that the nodes may have similar and sufficient resources to communicate, similar lack of interference, etc. This may be understood to improve the performance of the process, since it may be ensured that the masks of opposite signs that may be setup between the members of the pairs may be cancelled out, and that there may be no asymmetrical pairs, where one member may drop out of the message passing, and as a result, the information born in the message of the well-performing pair member may have to be discarded, meaning that it may never reach the node in charge of analyzing the information.

The locality of reference of each node may be taken into consideration by evaluating information available about the neighboring nodes of each node. Such information may be available in a set of correspondences, e.g., a table, such as an NRT table. Each node, e.g., cell, may be understood to have this information.

According to the foregoing in this Action 601, the first node 111 may obtain a set of correspondences of respective neighbor relations. The set of correspondences of respective neighbor relations may be, for example, an NRT table.

The set of correspondences may comprise respective relationships among the plurality of nodes 110. The first node 111 may obtain the respective relationships, e.g., as respective sets of correspondences, from each of the second node 112, the third node 113 and the fourth node 114. For example, the first node 111 may obtain a first set of correspondences, e.g., a first NRT table, from the second node 112, a second set of correspondences, e.g., a second NRT table, from the third node 113, and a third set of correspondences, e.g., a third NRT table, from the fourth node 114.

Obtaining may be understood as receiving, acquiring, generating, calculating or compiling.

As stated earlier, the different nodes and their interrelationships in the communications system 100 may be represented as a graph, where a vertex may be understood to be a node, and a relationship between two vertices may be understood to be an edge. Similarly, the respective neighbor relations in the set of correspondences may be represented as a graph, e.g., an NRT graph. The graph of the set of correspondences of respective neighbor relations may either be represented as a sparse adjacency matrix or as a dictionary of lists, where each key may be a parent node, and each value may be a list containing the children of that node.

Since the set of correspondences of respective neighbor relations may be understood to be designed to be automatically updated when new cells may be discovered by the UEs, the corresponding entries of the set of correspondences of respective neighbor relations may also be updated and, as such, the communications system 100 may be understood to learn to communicate with new nodes and/or cells.

There may be understood to be two different groups of embodiments herein. In a first group, a centralized approach may be followed, e.g., wherein the method may be triggered by a central node, such as e.g., an Operation and Maintenance (OAM) node. In such embodiments, the first node 111 may be a different node from any of the second node 112, the third node 113 and the fourth node 114. In some particular embodiments, the first node 111 may be the OAM node.

In the case of the centralized approach, the graph may have been constructed centrally in this Action 601 by combining all sets of correspondences of respective neighbor relations, e.g., NRT tables, from each node in the communications system 100. In other words, this Action 601 may be performed in embodiments wherein the centralized approach may be followed.

In a second group, a decentralized approach may be followed, wherein each node may rely on its own set of correspondences of respective neighbor relations to perform Action 602, as will be explained next, and Action 603, and, later, in Action 605, to start building pairs.

By obtaining the set of correspondences of respective neighbor relations in this Action 601, the first node 111 may be enabled to determine which nodes may be parents and which node may be children, and in sum, which nodes may be available to form pairs of nodes, according to Action 605. Since there may be understood to be no centralized graph that may know all relationships between every node, in this Action 601, the first node 111 may need to discover it hop-by-hop. Eventually, the process may iterate over the entire plurality of nodes 110, iteratively. Thus, the same information may be gained as if a centralized graph with all relations was available.

### Action 602

In this Action 602, the first node 111 may determine the one or more first children nodes 122 of the first node 111.

To support subgraphs, the process may be bound up to a certain level meaning that the children of the children of a node may be considered as subgraphs, and the pairing process afterwards may use them in their entirety as pairs, for coarse-grained output, as opposed to a fine-grained output, which may be denoted by levels=−1, where pairs may be constructed down to the last leaves of a graph. This process is described later in a non-limiting example by Algorithm 1.

Algorithm 1, referred to as a “reference_nodes_and_children” procedure may be understood to be a graph traversal algorithm. That is, it may find parents, that is, reference nodes, and their children. To do that, the procedure may start from a node and then ask this node who are its children, then ask the children about their children and so on. Afterwards, two arrays may be obtained, one that may contain the parents, and another one that may contain arrays of arrays, where each array may be the set of children per parent, e.g., (parent1, parent2, . . . ) ((child1, child2, child3), (child4, child5, child2, . . . )). In this example, parent2 has (child4, child5, child2, . . . ). A reference node may be understood to be connected to at least two other nodes.

Determining may be understood as calculating, choosing, selecting, etc.

### Centralized Approach

In the centralized approach, in this Action 602, the first node 111 may for example, retrieve reference nodes and their children from the first set of correspondences of neighbor relations of the first node 111, e.g., the NRT graph, based on a start_node. A start_node may be understood as the node that may call this procedure. That is, a node in the communications system 100 that may trigger this process, for example, every time collection of data may be needed. In examples herein, the first node 111 may be chosen as the start_node, which may be, e.g., an OAM.

### Decentralized Approach

In some embodiments, the first node 111 may determine the one or more first children nodes 122 of the first node 111, which may be chosen as a start node, based on a respective first set of correspondences of neighbor relations of the first node 111. That is based on a local set of correspondences of neighbor relations of the first node 111, e.g., a local NRT table. In such embodiments, Action 602 may be understood to be performed as an alternative to Action 601, in embodiments wherein the decentralized approach may be followed. That is, this Action 602 may be performed in embodiments wherein the first node 111 may be one of the second node 112, the third node 113 and the fourth node 114. The main difference between the centralized and the decentralized case may be understood to be that in the decentralized case, there may be understood to be no holistic graph of the set of correspondences of respective neighbor relations, e.g., no nrt_graph, as described in Action 601. Instead, the pairs may be discovered as the set of correspondences of respective neighbor relations of each node, e.g., each node's local NRT table, may be traversed. In the decentralized approach, in this Action 602, since the graph may be understood to be that of a single node, the first node 111 may be bound to that and therefore produce only the children of the first node 111.

The respective first set of correspondences of neighbor relations of the first node 111, e.g., the input nrt_graph, may be understood to be a single node's set of correspondences of respective neighbor relations, e.g., a single cell's NRT table. In these embodiments, extract_children may be used as a shortcut for reference_nodes_and_children, where nrt_graph may be understood to refer to the local nrt_table.

By, in this Action 602, determining the one or more first children nodes 122 of the first node 111, the first node 111 may be enabled to know the possible nodes which may be used as pairs.

### Action 603

In some embodiments, in this Action 603, the first node 111 may determine the one or more second children nodes 123 of every, e.g., another, node in the pair of nodes 112, 113, child node by child node. If the first node 111 is one of the nodes in the pair of nodes 112, 113, and it's one or more first children nodes 122 may have already been determined in Action 602, the determining in the Action 603 may be for one or more second children nodes 123 of the other node in the pair of nodes 112, 113. It may be understood that at this point, in some embodiments, such as in the centralized approach, it may not have been determined yet whether the second node 112 and the third node 113 may be paired. It may be understood that the determining of the one or more second children nodes 123 of every node in the pair of nodes 112, 113 may be performed as part of determining the children nodes of nodes within the plurality of nodes 110. It may so happen that as part of this process, some of the nodes may end up being identified as forming part of a pair, in Action 605.

The determining in this Action 603 may be performed in embodiments wherein the first node 111 may be one of the second node 112, the third node 113 and the fourth node 114.

In some embodiments, such as in the decentralized approach, the determining in this Action 603 of the one or more second children nodes of another node, e.g., the other node, in the pair of nodes 112, 113, may be performed after negotiating the respective masks between the pair of nodes 112, 113 and before the masked information comprised in the messages may be passed from the second node 112 and the third node 113 to the fourth node 114. That is, in some embodiments, this Action 603 may be performed after performing Action 605.

By determining the one or more second children nodes 123 of every node in the pair of nodes 112, 113 in this Action 603, the first node 111 may be enabled to, in the decentralized approach, continue to spread out to other nodes in the plurality of nodes 110 for the establishment of pairs of nodes. This may be understood to enable to scan the entire plurality of node 110 by traversing relations between nodes, thus eliminating the need for a centralized view of such a graph.

### Action 604

In this Action 604, the first node 111 may select the fourth node 114 for aggregation of the information. The selection in this Action 604 may be based on whether the second node 112 and the third node 113, in other words, the nodes that may be selected as forming a pair, are to respectively comprise information on an individual node, or on a respective plurality of children nodes 122, 123. As stated earlier, to support subgraphs, the process may be bound up to a certain level meaning that the children of the children of a node may be considered as subgraphs, and the pairing process afterwards may use them in their entirety as pairs, for coarse-grained output, as opposed to a fine-grained output, denoted by levels=−1, where pairs may be constructed down to the last leaves of the graph. A non-limiting example of this process is described by Algorithm 1, which will be described further down.

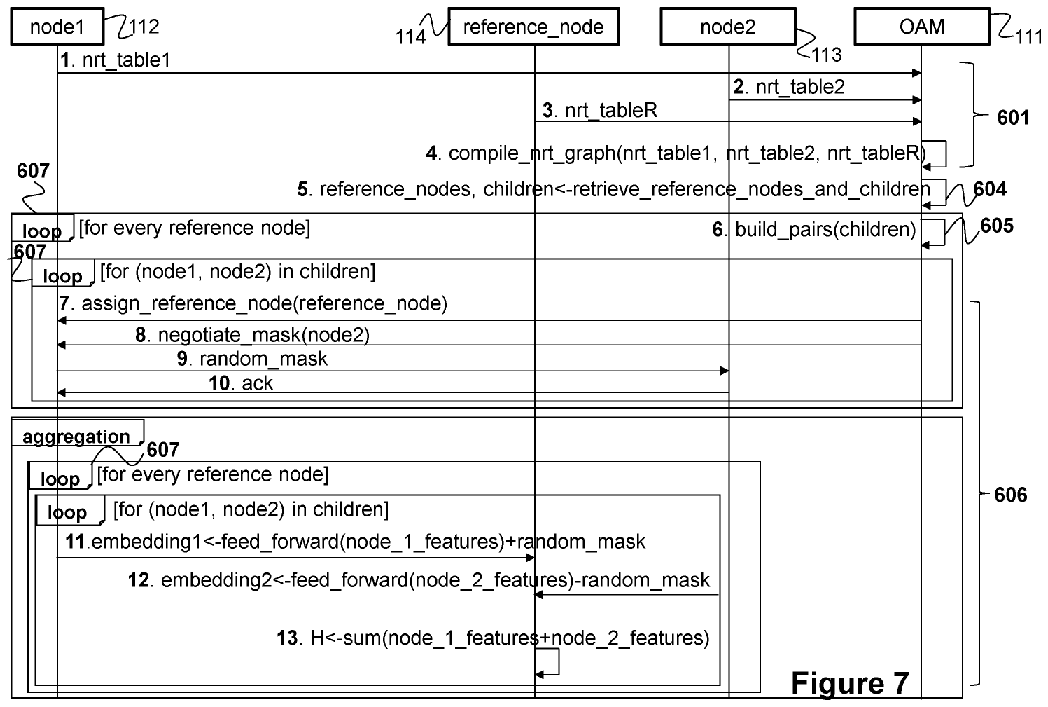

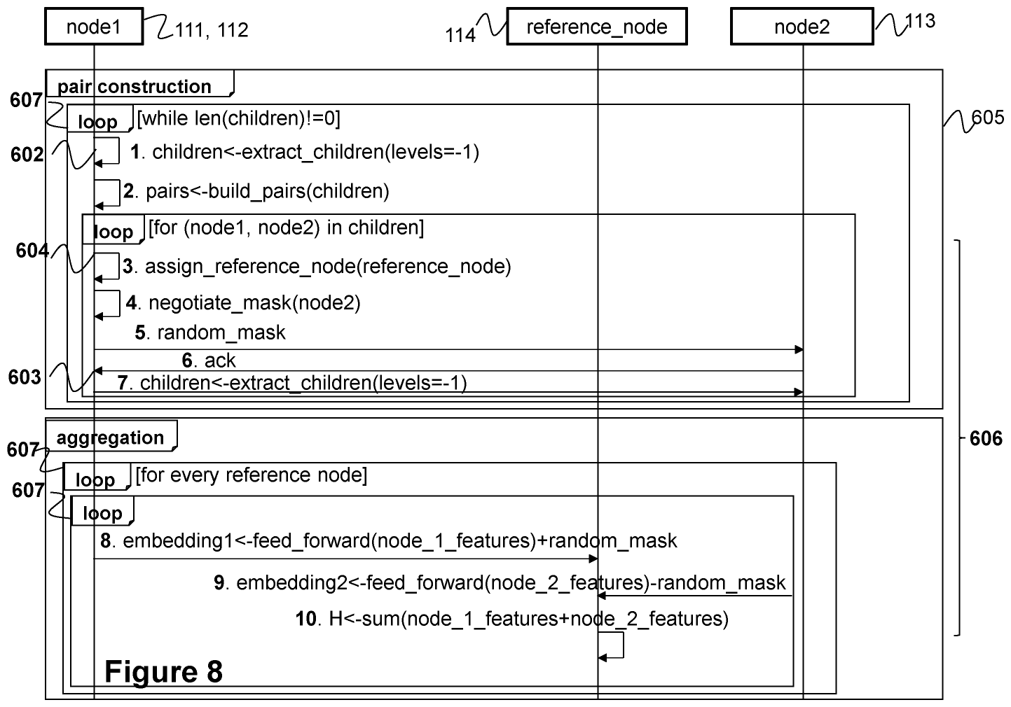

As will be illustrated later in the non-limiting examples of FIG. 7 and FIG. 8, this Action 604 may be performed, in some examples such as that of FIG. 7, before Action 605, and in other examples such as that of FIG. 8, after Action 605.

### Centralized Approach

In the case of the centralized approach, in a first phase, the reference nodes and their children may be retrieved according to this Action 604, from the set of correspondences of respective neighbor relations obtained in Action 601. That is, from the NRT graph, based on the start_node. In this case, the set of correspondences of respective neighbor relations, the NRT graph, may have been constructed centrally by combining all NRT tables from each node in the communications system 100.

Accordingly, the selecting in this Action 604 of the fourth node 114 may be further based on the obtained sets of correspondences of respective neighbor relations in Action 601. The sets of correspondences of respective neighbor relations in Action 601, e.g., the NRT graph, may either be represented as a sparse adjacency matrix or as a dictionary of lists where each key may be the parent node, and each value may be a list containing the children of that node.

### Decentralized Approach

In particular embodiments wherein the first node 111 may be one of the second node 112, the third node 113 and the fourth node 114, as depicted for example in FIG. 5c, at least one of the following may apply. According to a first option, in some embodiments, the selecting in Action 604 of the fourth node 114 may be performed after the determining in Action 605 of the pair of nodes 112, 113. According to a second option, in some embodiments, the determining in Action 603 of the one or more second children nodes of every node in the pair of nodes 112, 113, may be performed after negotiating the respective masks between the pair of nodes 112, 113 and before the masked information comprised in the messages may be passed from the second node 112 and the third node 113 to the fourth node 114.

According to the foregoing it may be understood that in some examples, the fourth node 114 may be determined first, e.g., based on the topology of the plurality of nodes 110, and then based on its identity, the pair of node 112, 113 may be determined in the next Action 605, and in other examples, the pair of nodes 112, 113 may be determined first in the next Action 605, and then, the fourth node 114 may be determined based on the identity of the members of the pair of nodes 112, 113.

By selecting the fourth node 114 for aggregation of the information in this Action 604, the first node 111 may then be enabled initiate aggregation of the information, by passing messages to the another node 114 for aggregation of information comprised in the messages.

### Action 605

In this Action 605, the first node 111 determines, out of the plurality of nodes 110, which nodes are to be paired (or grouped) as a pair of nodes 112, 113. The pairing as the pair of nodes 112, 113 is performed to pass messages to the another node 114 for aggregation of information comprised in the messages. The information is to be masked by respective masks of opposite signs to be assigned to the nodes comprised in the pair nodes 112, 113. The respective masks are to prevent the another node 114 from accessing the information respectively comprised in the respective messages passed from the pair of nodes 112, 113 while enabling their aggregation. That is, preserving privacy while enabling aggregation. The another node 114 may be understood to be the further node 114.

The information may comprise, for example, data indicating one or more aspects of a performance of the communications system 100.

The determining in this Action 605 is based on a respective measure of reliability of communications of the second node 112 and the third node 113 comprised in the pair of nodes 112, 113 being similar according to a criterion. In other words, the communication reliability between cells may be considered when setting up pairs. In the case of multiple neighbors, pairs may be chosen based on their reliability, so that equally reliable/unreliable cells may be paired together. The measure of reliability may be based on one or more indications of performance in handling transmissions. The one or more indications may indicate at least one of: experience interference, number of handovers, number of call drops, throughput, power of transmission, quality of transmission, latency and existence of a wired connection, e.g., an X2 link, between the pair of nodes 112, 113. In other words, the calculation of reliability may be implemented as a composite metric which may include, among others, the number of successful handovers between the nodes, the number of packets drops, the latency and the throughput of each node and more metrics. The criterion may therefore be set dependent on the measure of reliability, e.g., metric, used. For example, the criterion may be that the number of handovers may only differ by ±x amount, or the number of call drops may only differ by ±y amount.

According to the foregoing, in a second phase, the first node 111 may make use of the determined fourth node 114, e.g., the reference nodes, and their children to determine the pairs in the graph. To do that, the first node 111 may also take into consideration the reliability of the communication between the nodes, and pair nodes with equal reliability, so that nodes that may be equally unreliable may have the same chance as failing thus minimizing the potential risk of the pair.

In some embodiments, at least one of the following may apply. In some particular embodiments, each of the nodes in the plurality of nodes 110 may respectively comprise information on an individual node, or on a respective plurality of children nodes. In other words, instead of constructing pairs between cells and nodes, pairs may be constructed between different neighboring subgraphs, thus creating a more coarse-grained aggregation. In some particular embodiments, each of the second node 112 and the third node 113 may respectively comprise information on an individual node, or on a respective plurality of children nodes 122, 123.

The pool of nodes amount which the reliability may be checked to form the pairs may be as large as the available children. For example, if the multiple eNBs are connected to the same Serving Gateway, which may be the fourth node 113, then the first node 111 may choose between all those pairs to determine the most reliable ones and pair them accordingly. Strong pairs may be joined together and weak pairs as well. Weak pairs may be excluded from the process.

### Centralized Approach

In the centralized approach case, the first node 111 may construct pairs based on some centrally aggregated input.

The determining in this Action 605 of the pair of nodes 112, 113 may be further based on the obtained sets of correspondences of respective neighbor relations in Action 601. In some embodiments, the determining in this Action 605 of the pair of nodes 112, 113 and the determining in Action 604 of the fourth node 114 may be further based on the obtained sets of correspondences of respective neighbor relations. In embodiments in the first group of embodiments relating to the centralized approach, the determining in this Action 605 may comprise a function, a build_pairs function, which may operate on a centrally aggregated collection of NRT tables.

The centralized approach may be understood to be more holistic and it may need to perform more filtering since the complete set of correspondences of respective neighbor relations, e.g., the NRT graph may have unreliable pairs. On the other hand, the centralized case may be understood to have access to more information and may be able to construct a much larger set of pairs since it may not need to discover it as it may go along.

### Decentralized Approach

In embodiments in the second group of embodiments relating to the decentralized approach, the determining in this Action 605 may comprise “scanning” neighbors based on their reliability. In this case, the first node 111 may construct pairs procedurally per node. The first node 111 in this case may be expected to branch out to different nodes as it may discover them, meaning that first, the first node 111 may build pairs between the second node 112 and other reliable nodes, and then it may ask the other nodes to build pairs and so on and so forth.

In embodiments wherein Action 602 may have been performed, the determining in Action 605 of the pair of nodes 112, 113 may be made out of the determined one or more first children 122.

In embodiments wherein Action 603 may have been performed, the determining in Action 605 of a new pair of nodes 115, 116 may be made out of the determined one or more second children 123.

In some embodiments, the selecting in Action 604 of the fourth node 114 may be performed before the determining in this Action 605 of the pair of nodes 112, 113. In some of such embodiments, the determining in this Action 605 of which nodes are to be paired as a pair of nodes 112, 113 may be based on the selected fourth node 114. The fourth node 114 may be understood to be a reference node to the second node 112 and the third node 113.

By in this Action 605, determining which nodes are to be paired as a pair of nodes 112, 113 based on the respective measure of reliability of communications of the second node 112 and the third node 113 being similar, the first node 111 may enable to only build reliable pairs. This may be understood to reduce the likelihood that one member of the pair may become a drop-out, thus resulting in loss of information from both participants. In other words, the first node 111 may be understood to prevent the physical loss of information comprised in the messages, while ensuring that privacy of the information comprised in the messages is preserved when aggregating the messages. Hence, the first node 111 may enable a more robust handling of the data, since more data may be gathered and ultimately used for its analysis. This may in turn enable a more accurate analysis of the information. Since the information may, e.g., relate to an internal status of the communications system 100, this may in turn enable an improved maintenance of the operation of the communications system 100.

As a further advantage, the first node 111 may enable that an operator of the communications system 100 may run untrusted processes per node, since such processes may now be incapable of reading raw information from neighboring nodes, thus preventing that sensitive information may be observed, and potentially exposed.

### Action 606

Once the pairs may have been constructed, they may then be used when information may need to be transferred. Instead of the second node 112, e.g., which may be represented herein as “node1”, sharing raw data directly with the fourth node 114, e.g., a reference node, the second node 112 may negotiate a mask with its pair, in this case the third node 113, which may be represented herein as “node2”, and then the information that may be shared may be masked in such a way that the fourth node 114, that is, the reference node, may not be able to read it. That is, it may not be able to determine exactly what it may have received from the second node 112, and what it may have received from the third node 113, but may still be able to perform some aggregate of that information.

In this Action 606, the first node 111 initiates aggregation of the messages passed from the determined pair of nodes 112, 113 to the another node 114. The another node 114 is the fourth node 114. The initiating in Action 606 of the aggregation of the messages may thereby facilitate an analysis of the performance and taking of a maintenance action in communications system 100.

The aggregation of the messages may comprise: a) negotiating the respective masks between the pair of nodes 112, 113 and b) aggregating at the fourth node 114 the masked information comprised in the messages passed from the second node 112 and the third node 113.

As stated above, by in this Action 605, initiating the aggregation of the messages passed from the determined pair of nodes 112, 113 to the another node 114, the first node 111 may enable to reduce the likelihood that information from both participants may be lost as a result of one of the members of the pair of nodes 112, 113 dropping out. In other words, the first node 111 may be understood to prevent the physical loss of information comprised in the messages, while ensuring that privacy of the information comprised in the messages is preserved when aggregating the messages. Hence, the first node 111 may enable a more robust handling of the data, since more data may be gathered and used for the analysis. This may in turn enable a more accurate analysis of the information. Since the information may relate to an internal status of the communications system 100, this may in turn enable an improved maintenance of the operation of the communications system 100.

As a further advantage, the first node 111 may enable that an operator of the communications system 100 may run untrusted processes per node, since such processes may now be incapable of reading raw information from neighboring nodes, thus preventing that sensitive information may be observed, and potentially exposed.

### Action 607

In this Action 607, the first node 111 may iterate the selecting of Action 604, the determining of Action 605, where nodes are to be paired as a pair of nodes 112, 113 and the initiating of Action 606 for every selected fourth node 114.

By iterating these actions in this Action 607, the first node 111 may ensure that the messages from the plurality of nodes 110 may be securely aggregated, successively, and may ultimately reach the node that may compile the information, which may then be analyzed. Based on that analysis, an action to address a result of the analysis may be taken. For example, if a node is determined to have a high rate of dropped calls in the absence of any evidence of high load, the identified node may be serviced to repair any faulty equipment which may be responsible for the high rate of dropped calls.

To briefly summarize the foregoing, embodiments herein comprise a method for exchanging messages between nodes which may construct pairs of nodes, which may correspond to e.g., cells or subgraphs, efficiently, by taking into consideration the locality of reference proposed by e.g., an NRT, and node e.g., cell, subgraph, reliability criteria as recorded by each node. The method may work in a centralized, e.g., triggered by an OAM node, or decentralized fashion. In the decentralized embodiments, each node may rely on its own set of correspondences of respective neighbor relations, e.g., each own NRT, and start building pairs. Embodiments herein may be understood to enable to construct pairs of nodes so that afterwards, when messages may be exchanged, privacy may be preserved. This is described with illustrative non-limiting examples in FIG. 7 for the centralized approach and in FIG. 8 for the decentralized approach.

FIG. 7 is a schematic diagram illustrating a non-limiting example of the interaction between the first node 111, the second node 112, the third node 113 and the fourth node 114, according to the group of embodiments herein relating to a centralized construction of pairs and aggregation. In this example, the first node 111 is different from any of the other nodes, and is an OAM. The second node 112 is depicted as node1, the third node 113 is depicted as node2, and the fourth node 114 is depicted as a reference_node. In steps 1, 2, 3 and 4, the set of correspondences of respective neighbor relations, here an nrt_graph, is constructed, according to Action 601, by aggregating the corresponding nrt tables from node1 received in step 1 as nrt_table 1, from node 2, received in step 1 as nrt_table 2, and from the reference node, received in step 3 as nrt_tableR. In step 5, a procedure which produces the reference nodes, such as the fourth node 114, and their corresponding children is performed. This procedure may be understood to be the first phase, out of the two phases, in the case of the centralized approach. In this first phase, the reference nodes and their children may be retrieved according to Action 604, from the set of correspondences of respective neighbor relations obtained in Action 601. That is, from the NRT graph, based on a start_node. In this case, the set of correspondences of respective neighbor relations, the NRT graph, may have been constructed centrally by combining all NRT tables from each node in the communications system 100. The NRT graph may either be represented as a sparse adjacency matrix or as a dictionary of lists where each key may be the parent node, and each value may be a list containing the children of that node. To support subgraphs, the process may be bound up to a certain level meaning that the children of the children of a node may be considered as subgraphs, and the pairing process afterwards may use them in their entirety as pairs, for coarse-grained output, as opposed to a fine-grained output, denoted by levels=−1, where pairs may be constructed down to the last leaves of the graph. A non-limiting example of this process is described by Algorithm 1, which will be described further down. Steps 6 to 10 may operate in a loop for every reference node. In step 6, corresponding to Action 605, a procedure may be performed corresponding to the second phase, which may construct the pairs of nodes, positive and negative, based on their reliability. In the second phase, the reference nodes and their children may be used to determine the pairs in the graph. To do that, the reliability of the communication between the nodes may be taken into consideration, and nodes with equal reliability may be paired, so that nodes that may be equally unreliable may have the same chance as failing thus minimizing the potential risk of the pair. A non-limiting example of this process is described by Algorithm 2, which will be described further down. Once the pairs may have been determined, steps 7-10 may run in a loop for every pair. Step 7 may assign the fourth node 114, a reference node, to the second node 112, node1, so that this node may know where the aggregation may take place. In step 8, the second node 112, node, 1 may negotiate a mask with the third node 113, node 2. In this case, the negotiation is simplified. It is assumed the scenario that whatever random number may be agreed between the two nodes, may be agreed in one shot. In a different example, a more sophisticated approach may take place, for example, instead of simply choosing a random number, that number may still be random but also related to the size of the embedding and other properties thereof, e.g., the length (len) of the embedding, maximum value in the embedding, low of the embedding, closest prime number to the sum of the embedding and others, to better conceal its information. In step 9, the negotiated random mask may be shared with the third node 113, node 2. In step 10, the third node 113, node 2, may acknowledge the mask. Steps 11-13 may be understood to relate to the aggregation phase, corresponding to Action 606, where now, since the masks may have been negotiated, a process of collecting data from the nodes in the pair of nodes 112, 113 may be performed. As such, they may run in two nested loops, per reference node and per pair, in accordance with Action 607. Step 11 may produce the embedding from the second node 112, node 1. Step 12 may produce the embedding from the third node 113, node 2, and in Step 13 the two embeddings may be aggregated. If either of the pairs fails to produce a response in these steps, the iteration may be omitted, and the process may move on to the next reference node.

The following is a non-limiting example of an algorithm to illustrate the centralized approach. Algorithm 1 corresponds to the first phase, and Algorithm 2 corresponds to the second phase. Algorithm 1, referred to as a “reference_nodes_and_children” procedure may be understood to be a graph traversal algorithm. That is, it may find parents, that is, reference node, and their children. To do that, the procedure may start from a node and then ask this node who are its children, then ask the children about their children and so on and so forth. Afterwards, two arrays may be obtained, one that may contain the parents, and another one that may contain arrays of arrays, where each array may be the set of children per parent, e.g., (parent1, parent2, . . . ) ((child1, child2, child3), (child4, child5, child2, . . . )). In this example, parent2 has (child4, child5, child2, . . . ). In the second step, the procedure may choose the pairs between parents, e.g., reference nodes and children, based on reliability. The calculation of reliability may be implemented as a composite metric which may include, among others, the number of successful handovers between the nodes, the number of packets drops, the latency and the throughput of each node and more metrics. Since, from the previous step, the children of each parent may be known, the most reliable ones may be chosen using the calculate reliability function. The children may then be sorted based on reliability, and the most reliable may be associated, while discarding the rest. In the case where all of them may be equally reliable, multiple pairs may be built. Alternatively, in the case of multiple pairs, fallback pairs may also be considered, which may be used for redundancy when exchanging information. That is, when the original pair may fail due to reliability, the process of transferring data may consider another pair instead either in parallel, so have that pair may share data directly with the original pair, or as fallback in case of an error. The calculate_reliability function may act as a façade to any metric that may be considered, which may measure the reliability of a node, such as absence or existence of an x2 link, latency, throughput, number of dropped packets etc.

```
Algorithm 1 −>
data: nrt_graph, start_node, levels
result: reference_nodes, children
procedure reference_nodes_and_children
  visited <+ start_node
  queue <+ start_node
  current_level <− 0
  reference_nodes <− [ ]
  children_nodes <− [ ]
  while len(queue)>0 and current_level != levels
    reference_node = queue.pop(0)
    reference_nodes <+ reference_node
    children <− nrt_graph.get(reference_node, None)
    current_level <− current_level + 1
    if children is not None
      children_nodes <+ children
      for child in children
        if child not in visited
          visited <+ child
          queue <+ child
Algorithm 2 −>
data: children
result: pairs
procedure build_pairs
  for node in children
    reliability_stats[node] <− calculate_reliability(node)
  sorted <− sort(children, reliability_stats)
  pairs <− [ ]
  i <− 0
  while i<len(sorted)
    pairs <+ ( positive=sorted[i], negative=sorted[i+1] )
    i <− i+1
```

FIG. 8 is a schematic diagram illustrating another non-limiting example of the interaction between the first node 111, the second node 112, the third node 113 and the fourth node 114, according to the group of embodiments herein relating to a decentralized construction of pairs and aggregation. In this example, the first node 111 is the same node as the second node 112, which is depicted as node1, the third node 113 is depicted as node2, and the fourth node 114 is depicted as a reference_node. The main difference between the centralized and the decentralized case is that in the decentralized case there may be understood to be no holistic set of correspondences of respective neighbor relations, e.g., nrt_graph, anymore, but instead the pairs may be discovered as each node's local NRT table may be traversed. The decentralized case is deprived of an OAM node. Algorithms 1 and 2 described above may work the same as before, but the input nrt_graph may be understood to be a single node's NRT table. In this flow, extract_children may be used as a shortcut for reference_nodes_and_children, where nrt_graph may be understood to correspond to the respective first set of correspondences of neighbor relations of the first node 111, referred to also as the local nrt_table, start_node may be understood to correspond to the node that may call this procedure, and levels may be understood to correspond to the same as previously defined. In the decentralized case, the construction of pairs from the individual node in the communications system 100 may be done by following the children of each node. In step 1, the children of a node may be extracted, in agreement with Action 602. In this case, produced “reference_nodes_and_children” may be reused, but since the graph is that of a single cell, the process may be bound to that and therefore, may produce only the children of that node. Afterwards, using this information, pairs may be constructed in step 2, in agreement with Action 605. Steps 3-7 may run in a loop and here, the random mask may be negotiated in a same manner as in the centralized case. In step 7, in agreement with Action 603, the third node 113, node 2, may be asked to produce its children and that may update the traversal variable children, which may be used to spread out to other nodes. Step 1-7 may operate in a loop, in agreement with Action 607, until a node that does not have any children (leaf) may be reached. Step 8-10 are about the aggregation phase, in agreement with Action 606, and as such, may operate in the same way as we described previously in the centralized case for steps 11-13.

Embodiments herein may also comprise a method performed by the communications system 100, e.g., comprising the first node 111, the second node 112, the third node 113, and the further node 114 according to any of the above-described embodiments.

Embodiments herein may also comprise a method performed by the communications system 100, e.g., comprising the first node 111, the second node 112, the third node 113 and the fourth node 114, according to any of the above-described embodiments, and any of the above-described optional embodiments.

Certain embodiments disclosed herein may provide one or more of the following technical advantage(s), which may be summarized as follows. Embodiments disclosed herein may be understood to provide the advantage of enabling to an efficient approach for generating pairs of nodes/cells which may enable them to share their features, as embeddings, or raw data, in for example, the context of training a graph neural network, or in the context of aggregating raw data for other statistical operations.

As a further advantage, embodiments disclosed herein may be understood to takes into consideration the reliability of communication between each pair of nodes, which may reduce the likelihood that one part of the pair may become a drop-out thus resulting in loss of information from both participants.

As a further advantage, embodiments disclosed herein may be understood to be able to either exist as a proprietary implementation and co-exist with operators that may not have implemented embodiments herein, without any modifications, or it can be standardized thus enabling multi-operator support.

As a further advantage, embodiments disclosed herein may be understood to enables an operator to run untrusted processes per node, e.g., cell, since such processes may now be incapable of reading raw information from neighboring cells, thus observing, and potentially exposing, sensitive information.

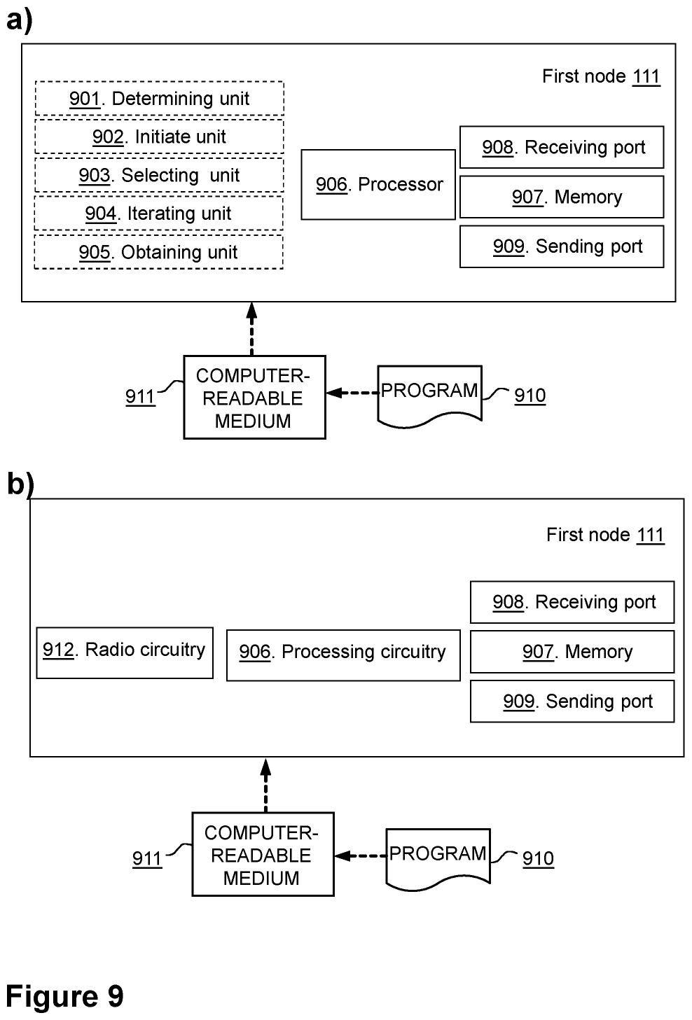

FIG. 9 depicts two different examples in panels a) and b), respectively, of the arrangement that the first node 111 may comprise. In some embodiments, the first node 111 may comprise the following arrangement depicted in FIG. 9a. The first node 111 may be understood to be for handling aggregation of message. The first node 111 is configured to operate in the communications system 100 configured to comprise the plurality of nodes 110.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first network node 111 and will thus not be repeated here. For example, the first node 111 may be configured to be an OAM node.

In FIG. 9, optional units are indicated with dashed boxes.

The first node 111 is configured to, e.g. by means of a determining unit 901 within the first node 111 configured to, determine, out of the plurality of nodes 110, which nodes are to be paired as a pair of nodes 112, 113 to pass messages to the another node 114 for aggregation of information configured to be comprised in the messages. The information is configured to be to be masked by the respective masks of opposite signs configured to be assigned to the nodes comprised in the pair nodes 112, 113. The respective masks are configured to prevent the another node 114 from accessing the information configured to be respectively comprised in the respective messages configured to be passed from the pair of nodes 112, 113 while enabling their aggregation. The determining is configured to be based on the respective measure of reliability of communications of the second node 112 and the third node 113 configured to be comprised in the pair of nodes 112, 113 being configured to be similar according to the criterion.

The first node 111 is further configured to, e.g. by means of an initiating unit 902 within the first node 111 configured to, initiate the aggregation of the messages configured to be passed from the pair of nodes 112, 113 configured to be determined to the another node 114. The another node 114 is configured to be the fourth node 114.

In some embodiments, the information is configured to comprise data configured to indicate one or more aspects of a performance of the communications system 100. The initiating of the aggregation of the messages may thereby be configured to facilitate the analysis of the performance and taking of a maintenance action in the communications system 100.

In some embodiments, at least one of the following options may apply. According to a first option, each of the nodes in the plurality of nodes 110 may be configured to respectively comprise information on an individual node, or on a respective plurality of children nodes. According to a second option, each of the second node 112 and the third node 113 may be configured to respectively comprise information on an individual node, or on a respective plurality of children nodes 122, 123.

In some embodiments, the measure of reliability may be configured to be based on one or more indications of a performance in handling transmissions.

In some embodiments, the one or more indications may be configured to indicate at least one of: experience interference, number of handovers, number of call drops, throughput, power of transmission, quality of transmission, latency and existence of the wired connection between the pair of nodes 112, 113.

The first node 111 may be configured to, e.g. by means of a selecting unit 903 within the first node 111 configured to, select the fourth node 114 for aggregation of the information. The selecting may be based on whether the second node 112 and the third node 113 may be to respectively comprise information on an individual node, or on a respective plurality of children nodes 122, 123. The determining of which nodes are to be paired as a pair of nodes 112, 113 may be configured to be based on the selected fourth node 114.

In some embodiments, the first node 111 may be configured to, e.g. by means of an iterating unit 904 within the first node 111 configured to, iterate the selecting, the determining of which nodes are to be paired as a pair of nodes 112, 113 and the initiating, for every selected fourth node 114.

In some embodiments, the aggregation of the messages may be configured to comprise: a) negotiating the respective masks between the pair of nodes 112, 113 and b) aggregating at the fourth node 114 the masked information configured to be comprised in the messages configured to be passed from the second node 112 and the third node 113.

In some embodiments wherein the first node 111 may be configured to be a different node from any of the second node 112, the third node 113 and the fourth node 114, the first node 111 may be further configured to, e.g. by means of an obtaining unit 905 within the first node 111 configured to, obtain the set of correspondences of respective neighbor relations configured to comprise respective relationships among the plurality of nodes 110 from each of the second node 112, the third node 113 and the fourth node 114. The determining of the pair of nodes 112, 113 and the selecting of the fourth node 114 may be further configured to be based on the sets of correspondences of respective neighbor relations configured to be obtained.

In some embodiments, wherein at least one of the following options may apply. According to a first option, the first node 111 may be configured to be an OAM node. According to a second option, the selecting of the fourth node 114 may be configured to be performed before the determining of the pair of nodes 112, 113.

In some embodiments wherein the first node 111 may be configured to be one of the second node 112, the third node 113 and the fourth node 114, the first node 111 may be configured to, e.g. by means of the determining unit 901 within the first node 111 further configured to, determine the one or more first children nodes 122 of the first node 111 based on the respective first set of correspondences of neighbor relations of the first node 111. The determining of the pair of nodes 112, 113 may be configured to be made out of the one or more first children 122 configured to be determined.

In some of such embodiments wherein the first node 111 may be configured to be one of the second node 112, the third node 113 and the fourth node 114, the first node 111 may be further configured to, e.g. by means of the determining unit 901 within the first node 111 further configured to, determine the one or more second children nodes 123 of every node in the pair of nodes 112, 113. The determining of the new pair of nodes 115, 116 may be configured to be made out of the one or more second children 123 configured to be determined.

In some embodiments, at least one of the following options may apply. According to a first option, the selecting of the fourth node 114 may be configured to be performed after the determining of the pair of nodes 112, 113. According to a second option, the determining of the one or more second children nodes of another node in the pair of nodes 112, 113, may be configured to be performed after negotiating the respective masks between the pair of nodes 112, 113 and before the masked information configured to be comprised in the messages may be configured to be passed from the second node 112 and the third node 113 to the fourth node 114.

The embodiments herein in the first node 111 may be implemented through one or more processors, such as a processor 906 in the first node 111 depicted in FIG. 9a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 907 comprising one or more memory units. The memory 907 is arranged to be used to store obtained information, store data, configurations, scheduling, and applications etc. to perform the methods herein when being executed in the first node 111.

In some embodiments, the first node 111 may receive information from, e.g., the second node 112, the third node 113, the fourth node 114 or any of the other nodes in the plurality of nodes 110, through a receiving port 908. In some embodiments, the receiving port 908 may be, for example, connected to one or more antennas in first node 111. In other embodiments, the first node 111 may receive information from another structure in the communications network 100 through the receiving port 908. Since the receiving port 908 may be in communication with the processor 906, the receiving port 908 may then send the received information to the processor 906. The receiving port 908 may also be configured to receive other information.

The processor 906 in the first node 111 may be further configured to transmit or send information to e.g., the second node 112, the third node 113, the fourth node 114, any of the other nodes in the plurality of nodes 110, and/or another structure in the communications network 100, through a sending port 909, which may be in communication with the processor 906, and the memory 907.

Those skilled in the art will also appreciate that the units 901-905 described above may refer to a combination of analog and digital circuits, and/or one or more processors configured with software and/or firmware, e.g., stored in memory, that, when executed by the one or more processors such as the processor 906, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 901-905 described above may be implemented as one or more applications running on one or more processors such as the processor 906.

Thus, the methods according to the embodiments described herein for the first node 111 may be respectively implemented by means of a computer program 910 product, comprising instructions, i.e., software code portions, which, when executed on at least one processor 906, cause the at least one processor 906 to carry out the actions described herein, as performed by the first node 111. The computer program 910 product may be stored on a computer-readable storage medium 911. The computer-readable storage medium 911, having stored thereon the computer program 910, may comprise instructions which, when executed on at least one processor 906, cause the at least one processor 906 to carry out the actions described herein, as performed by the first node 111. In some embodiments, the computer-readable storage medium 911 may be a non-transitory computer-readable storage medium, such as a CD ROM disc, or a memory stick. In other embodiments, the computer program 910 product may be stored on a carrier containing the computer program 910 just described, wherein the carrier is one of an electronic signal, optical signal, radio signal, or the computer-readable storage medium 911, as described above.

The first node 111 may comprise a communication interface configured to facilitate communications between the first node 111 and other nodes or devices, e.g., the second node 112, the third node 113, the fourth node 114, any of the other nodes in the plurality of nodes 110, and/or another structure in the communications network 100. The interface may, for example, include a transceiver configured to transmit and receive radio signals over an air interface in accordance with a suitable standard.

In other embodiments, the first node 111 may comprise the following arrangement depicted in FIG. 9b. The first node 111 may comprise a processing circuitry 906, e.g., one or more processors such as the processor 906, in the first node 111 and the memory 907. The first node 111 may also comprise a radio circuitry 912, which may comprise e.g., the receiving port 908 and the sending port 909. The processing circuitry 906 may be configured to, or operable to, perform the method actions according to FIG. 6, and/or FIGS. 7-8, in a similar manner as that described in relation to FIG. 9a. The radio circuitry 912 may be configured to set up and maintain at least a wireless connection with the second node 112, the third node 113, the fourth node 114, any of the other nodes in the plurality of nodes 110, and/or another structure in the communications network 100. Circuitry may be understood herein as a hardware component.

Hence, embodiments herein also relate to the first node 111 operative to operate in the communications network 100. The first node 111 may comprise the processing circuitry 906 and the memory 907, said memory 907 containing instructions executable by said processing circuitry 906, whereby the first node 111 is further operative to perform the actions described herein in relation to the first node 111, e.g., in FIG. 6, and/or FIGS. 7-8.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

When using the word “comprise” or “comprising” it shall be interpreted as non-limiting, i.e. meaning “consist at least of”.

A processor may be understood herein as a hardware component.

The embodiments herein are not limited to the above-described preferred embodiments. Various alternatives, modifications and equivalents may be used. Therefore, the above embodiments should not be taken as limiting the scope of the invention.

1. A computer-implemented method performed by a first node, wherein the computer-implemented method being for handling aggregation of messages and the first node operating in a communications system comprising a plurality of nodes, the computer-implemented method comprising:
determining, out of the plurality of nodes, which nodes are to be paired as a pair of nodes to pass messages to another node for aggregation of information comprised in the messages, wherein the information is to be masked by respective masks of opposite signs to be assigned to the nodes comprised in the pair of nodes, wherein the respective masks are to prevent the another node from accessing the information respectively comprised in respective messages passed from the pair of nodes while enabling their aggregation, and wherein the determining is based on a respective measure of reliability of communications of a second node and a third node comprised in the pair of nodes being similar according to a criterion; and
initiating an aggregation of the messages passed from the determined pair of nodes to the another node, wherein the another node is a fourth node.

2. The computer-implemented method according to claim 1, wherein the information comprises data indicating one or more aspects of a performance of the communications system, and wherein the initiating of the aggregation of the messages thereby facilitates an analysis of the performance and taking of a maintenance action in the communications system.

3. The computer-implemented method according to claim 1, wherein at least one of:
each of the nodes in the plurality of nodes respectively comprises information on an individual node, or on a respective plurality of children nodes; and
each of the second node and the third node respectively comprises information on an individual node, or on a respective plurality of children nodes.

4. The computer-implemented method according to claim 1, wherein the respective measure of reliability is based on one or more indications of a performance in handling transmissions.

5. (canceled)

6. The computer-implemented method according to claim 1, wherein the computer-implemented method further comprises:
selecting the fourth node for aggregation of the information, the selecting being based on whether the second node and the third node are to respectively comprise information on an individual node, or on a respective plurality of children nodes, the determining of which nodes are to be paired as a pair of nodes being based on the selected fourth node.

7. (canceled)

8. The computer-implemented method according to claim 1, wherein the aggregation of the messages comprises: negotiating the respective masks between the pair of nodes; and aggregating at the fourth node the masked information comprised in the messages passed from the second node and the third node.

9. The computer-implemented method according to claim 6, wherein the first node is a different node from any of the second node, the third node and the fourth node, and wherein the computer-implemented method further comprises:
obtaining a set of correspondences of respective neighbor relations comprising respective relationships among the plurality of nodes from each of the second node, the third node, and the fourth node; and wherein the determining of the pair of nodes and the selecting of the fourth node is further based on the obtained sets of correspondences of respective neighbor relations.

10. The computer-implemented method according to claim 9, wherein at least one of:
the first node is an Operation and Maintenance (OAM) node; and
the selecting of the fourth node is performed before the determining of the pair of nodes.

11. The computer-implemented method according to claim 1, wherein the first node is one of the second node, the third node and the fourth node, and wherein the computer-implemented method further comprises:
determining one or more first children nodes of the first node based on a respective first set of correspondences of neighbor relations of the first node, and wherein the determining of the pair of nodes is made out of the determined one or more first children nodes; and
determining one or more second children nodes of every node in the pair of nodes, and wherein determining of a new pair of nodes is made out of the determined one or more second children nodes.

12. The computer-implemented method according to claim 6, wherein at least one of:
the selecting of the fourth node is performed after the determining of the pair of nodes; and
determining of one or more second children nodes of another node in the pair of nodes, is performed after negotiating the respective masks between the pair of nodes and before the masked information comprised in the messages is passed from the second node and the third node to the fourth node.

13. A first node, for handling aggregation of messages, wherein the first node to operate in a communications system comprised of a plurality of nodes, the first node comprising:
a processor; and
a memory comprising computer program code, which computer program code when executed by the processor, cause the first node to:
determine, out of the plurality of nodes, which nodes are to be paired as a pair of nodes to pass messages to another node for aggregation of information comprised in the messages, wherein the information is be masked by respective masks of opposite signs to be assigned to the nodes comprised in the pair of nodes, wherein the respective masks are to prevent the another node from accessing the information respectively comprised in the respective messages passed from the pair of nodes while enabling their aggregation, and wherein to determine is based on a respective measure of reliability of communications of a second node and a third node comprised in the pair of nodes being similar according to a criterion; and
initiate an aggregation of the messages passed from the pair of nodes to the another node, wherein the another node is a fourth node.

14. The first node according to claim 13, wherein the information comprises data to indicate one or more aspects of a performance of the communications system, and wherein to initiate the aggregation of the messages is thereby to facilitate an analysis of the performance and taking of a maintenance action in the communications system.

15. The first node according to claim 13, wherein at least one of:
each of the nodes in the plurality of nodes respectively comprises information on an individual node, or on a respective plurality of children nodes; and
each of the second node and the third node respectively comprises information on an individual node, or on a respective plurality of children nodes.

16. The first node according to claim 13, wherein the respective measure of reliability is based on one or more indications of a performance in handling transmissions.

17. (canceled)

18. The first node according to claim 13, wherein the first node is further to:
select the fourth node for aggregation of the information, the selecting being based on whether the second node and the third node are to respectively comprise information on an individual node, or on a respective plurality of children nodes, the determining of which nodes are to be paired as a pair of nodes being based on the selected fourth node.

19. (canceled)

20. The first node according to claim 13, wherein the aggregation of the messages comprises: to negotiate the respective masks between the pair of nodes; and to aggregate at the fourth node the masked information comprised in the messages passed from the second node and the third node.

21. The first node according to claim 18, wherein the first node is a different node from any of the second node the third node and the fourth node, and wherein the first node is further to:
obtain a set of correspondences of respective neighbor relations comprising respective relationships among the plurality of nodes from each of the second node, the third node, and the fourth node; and wherein to determine the pair of nodes and to select of the fourth node is further based on the sets of correspondences of respective neighbor relations that are obtained.

22. The first node according to claim 21, wherein at least one of:
the first node is an Operation and Maintenance (OAM) node; and
to select the fourth node is to be performed before determination of the pair of nodes.

23. The first node according to claim 13, wherein the first node is one of the second node, the third node and the fourth node, and wherein the first node is further to:
determine one or more first children nodes of the first node based on a respective first set of correspondences of neighbor relations of the first node, and wherein to determine the pair of nodes is made out of the one or more first children nodes that are determined; and
determine one or more second children nodes of every node in the pair of nodes (112, 113), and wherein to determine a new pair of nodes is made out of the one or more second children nodes that are determined.

24. The first node according to claim 18, wherein at least one of:
to select the fourth node is performed after determination of the pair of nodes; and
to determine one or more second children nodes of another node in the pair of nodes, is performed after negotiating the respective masks between the pair of nodes and before the masked information comprised in the messages is passed from the second node and the third node to the fourth node.

25-26. (canceled)
